(19) United States
(12) Patent Application Publication
(10) Pub. No.: US 2021/0402263 A1
(43) Pub. Date: Dec. 30, 2021

(54) Stitchless Sportsball and Manufacturing Method Thereof

(71) Applicant: Tsung Ming OU, Kaohsiung (TW)

(72) Inventor: Tsung Ming OU, Kaohsiung (TW)

(21) Appl. No.: 16/914,469

(22) Filed: Jun. 29, 2020

(51) Int. Cl. A63B 45/00; A63B 41/10; B29D 22/02

(52) U.S. Cl. CPC A63B 45/00; A63B 2243/0025; B29D 22/02; A63B 41/10

(57) ABSTRACT

A method of manufacturing a stitchless sportsball includes the steps of: forming an integrated ball bladder; pre-making an integrated ball cover; cutting the integrated ball cover into a plurality of ball panels; and adhering the ball panels onto an outer spherical surface of the integrated ball bladder for encasing the integrated ball bladder within the integrated ball cover to form a sportsball and to form a plurality of ball channels on the sportsball. The integrated ball bladder includes an inflatable bladder encased in a reinforcing carcass in a stitch-less manner, wherein the inflatable bladder is vulcanized and integrally bonded with the reinforcing carcass for forming the integrated ball bladder in order to enhance a strength and roundness of the integrated ball bladder.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to sports balls, and more particularly to a stitchless sportsball and manufacturing method thereof, which comprises an integrated ball bladder encased within a ball cover in a stitch-less manner to strengthen and compact the ball structure for better performance.

### Description of Related Arts

A conventional sportsball, such as a conventional soccer ball, generally comprises a ball bladder, an inner lining, and a ball casing. The ball casing comprises a plurality of casing panels attached on the ball bladder, wherein the casing panels are stitched edge-to-edge to encase the ball bladder for forming a sportsball. Accordingly, the cover panels can be made of leather or rubber. The cover panels, being attached onto the ball bladder, involve expensive and time-consuming manufacturing procedures, yet the resulting sports ball may not have the optimal roundness.

Accordingly, the inner lining is constructed to have a ball pocket formed by a plurality of fabric layers, wherein adhesive is applied on the ball bladder to adhere the ball bladder within the ball pocket, such that the ball bladder is encased within the fabric layers before the cover panels are attached thereon. However, it is difficult to adhere the fabric layers on the ball bladder to provide an even strength all around the ball bladder. In other words, the bonding between ball bladder and the ball pocket is formed only by the adhesive. As a result, the configuration of the fabric layers will be deformed when the ball bladder is inflated or deflated.

The liner lining further comprises a cushioning layer adhered on the ball pocket, wherein vulcanization process is completed after the cushioning layer is laminated on the ball bladder with the fabric layers thereon. In other words, an extra step of vulcanization is required during the manufacturing method of the sportsball. Furthermore, it is difficult of adhering the cover panels on the soft and elastic cushioning layer, wherein the cover panels and/or cushioning layer may peel off after use due to the different attachment coefficients thereof.

For the purpose of easy holding and gripping, a plurality of ball channels are formed on the ball casing. Particularly, the channels are formed along edges of the cover panels. Since the cover panels are adhered on the cushioning layer or are stitched with each other edge-to-edge, it is difficult to form the ball channels, especially in an even and smooth manner, on the ball casing. Accordingly, the ball casing is not in spherical ball shape substantially and does not provide a round and smooth exterior surface that causes uneven stressing when being pressed. Although the presence of the ball channels between the cover panels enables the player to hold and grip the sportsball easier, the uneven ball channels adversely affect the flying, rolling and impacting performance of the sportsball in air and ground respectively. For example, when the player tries to rub the basketball against basketball backboard during shooting the basket, the rubbing of the uneven ball channels are different and may produce different effects. In other words, the shooting or passing performance of the conventional basketball is not predictable at all. Another shortage of the conventional sportsball is that the accuracy of distance between the ball channels is highly required to fit the shape of the cover panels. And the size of each cover panel is required to be appropriate correspondingly. These raise the manufacturing complexity in production and the cost of manufacturing.

### SUMMARY OF THE PRESENT INVENTION

The invention is advantageous in that it provides a stitchless sportsball and manufacturing method thereof, wherein the stitchless sportsball comprises an integrated ball bladder encased within a ball cover in a stitch-less manner to strengthen and compact the ball structure for better performance.

Another advantage of the invention is to provide a stitchless sportsball and manufacturing method thereof, wherein the integrated ball bladder is constructed to have a bladder body integrated with a reinforcing arrangement to enhance the strength and roundness of the integrated ball bladder.

Another advantage of the invention is to provide a stitchless sportsball and manufacturing method thereof, wherein the ball cover is premade to form a plurality of cover panels, wherein each cover panel is constructed to have an outer cover panel integrally bond with a cushioning layer.

Another advantage of the invention is to provide a stitchless sportsball and manufacturing method thereof, wherein the integrated ball bladder is constructed to have an integrated protruding ribs protruded therefrom so as to form a plurality of panel guidelines for the attachment of the ball cover.

Another advantage of the invention is to provide a stitchless sportsball and manufacturing method thereof, wherein a plurality of ball channels is formed on the ball cover when the cover panels are attached on the integrated ball bladder along the integrated protruding ribs.

Another advantage of the invention is to provide a stitchless sportsball and manufacturing method thereof, wherein a plurality of ball channels is formed on the ball cover by pressing and pushing two adjacent V-shaped stitch-imitation edges of the cover panels along the corresponding panel guideline.

Another advantage of the invention is to provide a stitchless sportsball and manufacturing method thereof, which do not involve complicated mechanical structure and process so as to minimize the manufacturing cost of the present invention.

Another advantage of the invention is to provide a stitchless sportsball and manufacturing method thereof, wherein the manufacturing method is simple, cost-effective, and efficient. In other words, the present invention provides an optimal method of producing a large quantity of stitchless sportsball in a relatively short period of time.

Another advantage of the invention is to provide a stitchless sportsball and manufacturing method thereof, wherein the sportsball can be manufactured into a wide variety of ball types, so as to facilitate widespread applications of the present invention. For example, the stitchless sportsball can be manufactured as a soccer ball, an America football, or even a volley ball.

Another advantage of the invention is to provide a stitchless sportsball and manufacturing method thereof, wherein no expensive or complicated structure is required to employ in the present invention in order to achieve the above mentioned objects. Therefore, the present invention successfully provides an economic and efficient solution for providing a simple and strengthened ball configuration for manufacturing a stitchless sportsball with integrated and strengthened ball bladder.

Additional advantages and features of the invention will become apparent from the description which follows, and may be realized by means of the instrumentalities and combinations particular point out in the appended claims.

According to the present invention, the foregoing and other objects and advantages are attained by a method of manufacturing a stitchless sportsball, comprising the following steps.

(1) Form an integrated ball bladder, having an outer spherical surface, by the following steps.

(1.1) Encase an inflatable bladder in a reinforcing carcass.

(1.2) Via a vulcanization process, integrally bond the inflatable bladder with the reinforcing carcass for forming the integrated ball bladder in order to enhance a strength and roundness of the integrated ball bladder.

(2) Pre-make an integrated ball cover.

(3) Cut the integrated ball cover into a plurality of ball panels.

(4) Adhere the ball panels onto the outer spherical surface of the integrated ball bladder for encasing the integrated ball bladder within the integrated ball cover to form a sportsball and to form a plurality of ball channels on the sportsball.

In accordance with another aspect of the invention, the present invention comprises a stitchless sportsball, comprising:

an integrated ball bladder which comprises an inflatable bladder and a reinforcing carcass, wherein the inflatable bladder is encased in, vulcanized, and integrally bonded with the reinforcing carcass for forming the integrated ball bladder in order to enhance a strength and roundness of the integrated ball bladder; and

an integrated ball cover which comprises a plurality of ball panels adhered onto an outer spherical surface of the integrated ball bladder to encase the integrated ball bladder within the integrated ball cover to form a sportsball with a plurality of ball channels on the sportsball formed thereon.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a stitchless sportsball according to a first preferred embodiment of the present invention.

FIG. 2 is a sectional view of the stitchless sportsball according to the first embodiment of the present invention, illustrating before and after the layer formation of the stitchless sportsball.

FIG. 3 illustrates the fabric layers being cut in particular shapes for wrapping on the ball bladder according to the first embodiment of the present invention, illustrating before and after the layer formation of the stitchless sportsball.

FIG. 4 illustrates the cover panels being cut in particular shapes for wrapping on the ball bladder according to the first embodiment of the present invention, illustrating before and after the layer formation of the stitchless sportsball.

FIG. 5 illustrates a first alternative mode of the cover panels being cut in particular shapes for wrapping on the ball bladder according to the first embodiment of the present invention, illustrating before and after the layer formation of the stitchless sportsball.

FIG. 6 illustrates a second alternative mode of the cover panels being cut in particular shapes for wrapping on the ball bladder according to the first embodiment of the present invention, illustrating before and after the layer formation of the stitchless sportsball.

FIG. 7 illustrates a third alternative mode of the cover panels being cut in particular shapes for wrapping on the ball bladder according to the first embodiment of the present invention, illustrating before and after the layer formation of the stitchless sportsball.

FIG. 8 illustrates the formation of the ball channels of the stitchless sportsball according to the first preferred embodiment of the present invention.

FIG. 9 is a schematic diagram of a method of manufacturing an integrated ball bladder of the stitchless sportsball according to the first preferred embodiment of the present invention.

FIG. 10 is a schematic diagram of a method of manufacturing an integrated ball cover of the stitchless sportsball according to the first preferred embodiment of the present invention.

FIG. 11 is a perspective view of a stitchless sportsball according to a second preferred embodiment of the present invention.

FIG. 12 is a sectional view of the stitchless sportsball according to the second embodiment of the present invention, illustrating before and after the layer formation of the stitchless sportsball.

FIG. 13 is a schematic diagram of a method of manufacturing an integrated ball bladder of the stitchless sportsball according to the second preferred embodiment of the present invention.

FIG. 14 illustrates the formation of the ball channels of the stitchless sportsball according to the second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

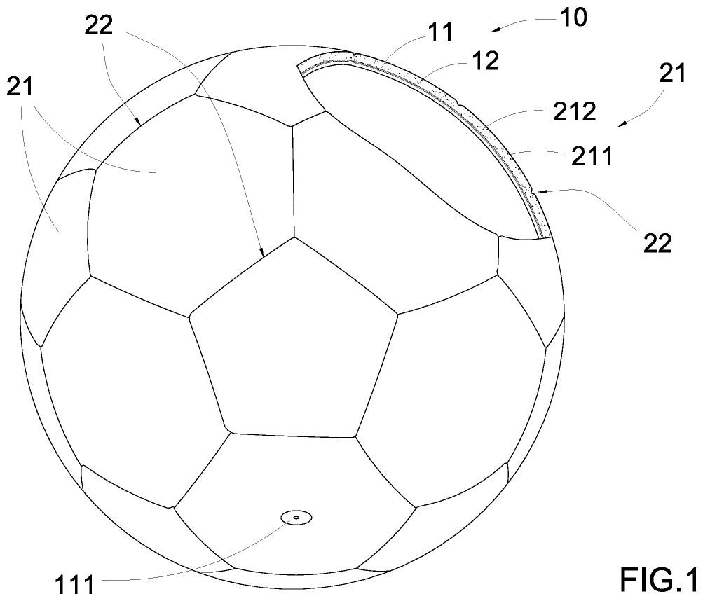

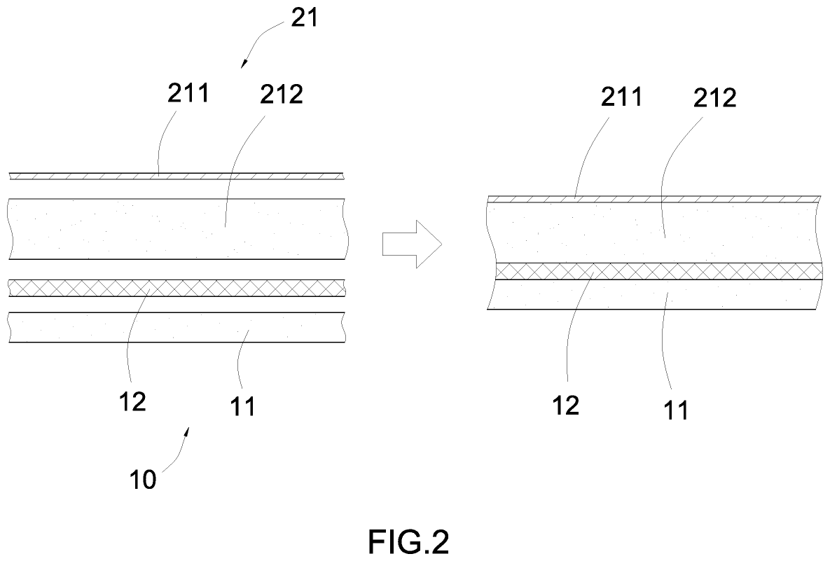

Referring to FIGS. 1 and 2 of the drawings, a stitchless sportsball according to a first preferred embodiment of the present invention. The stitchless sportsball is constructed to have a spherical shape as a volleyball ball, soccer ball, or a basketball ball. According to the first embodiment, the stitchless sportsball is shown as a volleyball ball or soccer ball as an example. The stitchless sportsball comprises an integrated ball bladder 10 and an integrated ball cover 20 to encase the integrate ball bladder 10 therewithin. The method of manufacturing the stitchless sportsball comprises the following steps.

(1) Form the integrated ball bladder 10.

(2) Form the integrated ball cover 20.

(3) Encase the integrated ball bladder 10 within the integrated ball cover 20 to form a sportsball in a stitch-less manner. In other words, no stitch is required in the entire manufacturing process of the stitchless sportsball of the present invention.

The integrated ball bladder 10 comprises an inflatable bladder 11 and a reinforcing carcass 12, wherein the inflatable bladder 11 is encased in, vulcanized, and integrally bonded with the reinforcing carcass 12 for forming the integrated ball bladder 10 in order to enhance a strength and roundness of the integrated ball bladder 10.

The integrated ball cover 20 comprises a plurality of ball panels 21 attached onto an outer spherical surface of the integrated ball bladder 10, preferably by adhering agent, for encasing the integrated ball bladder 10 within the integrated ball cover 20 to form a sportsball with a plurality of ball channels 22 formed thereon.

Accordingly, the inflatable bladder 11 is an inflatable bladder having a valve stem 111, wherein the inflatable bladder 11 is inflated via the valve stem 111 to have a spherical shape.

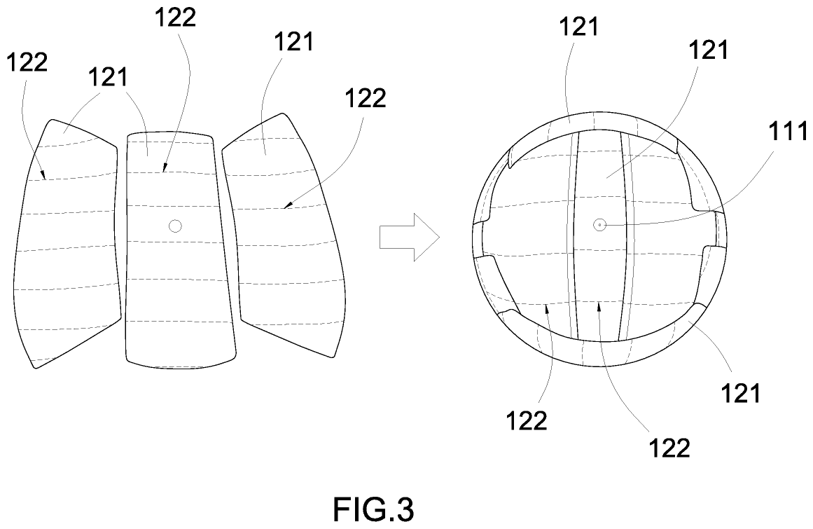

The reinforcing carcass 12 comprises a plurality of fabric layers 121 vulcanized and integrally bonded on an outer spherical surface of the inflatable bladder 11. The fabric layers 121 are cut in particular elongated shapes, as shown in FIG. 3, for wrapping on the ball bladder 11. Preferably, the fabric layers 121 are made of polyethylene. Each of the fabric layers 121 has a plurality of guiding marks 122 spacedly formed thereon, wherein the guiding marks 122 of the fabric layers 121 are aligned with each other when the fabric layers 121 are adhered on the outer spherical surface of the inflatable bladder 11. Preferably, edge portions of the fabric layers 121 are overlapped with each other on the outer spherical surface of the inflatable bladder 121 to align the guiding marks 122 with each other. Therefore, after the vulcanization process, the fabric layers 121 not only integrally bond with each other to form the reinforcing carcass 12 but also integrally bond on the outer spherical surface of the inflatable bladder 12, as shown in FIG. 2. It is worth mentioning that one of the fabric layers 121 has a through hole formed thereon to align with the valve stem 111 when the fabric layer 121 is adhered on the inflatable bladder 11. It is worth mentioning that the fabric layer 121 embraces the inflatable bladder 11 for resisting stress and impact force applied to the inflatable bladder 11.

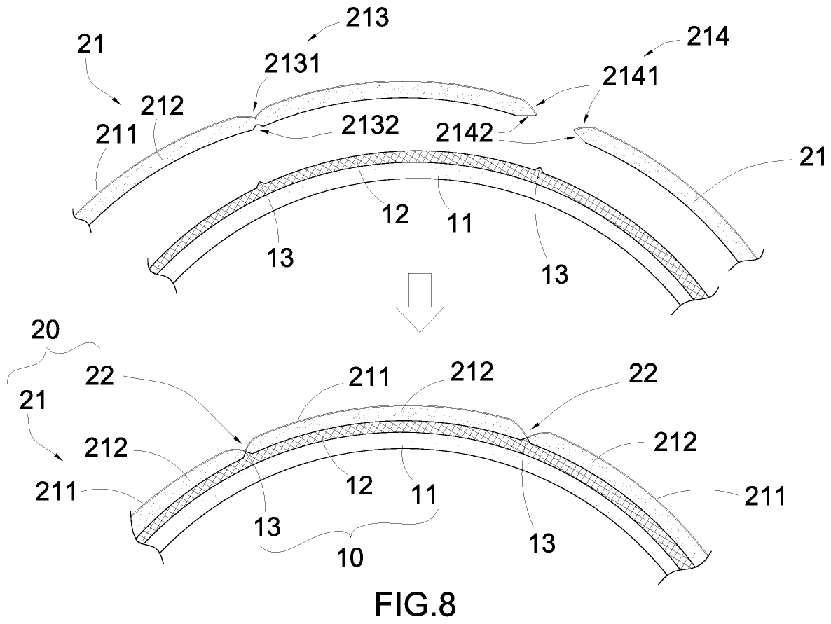

The integrated ball bladder 10 further comprises a plurality of panel guidelines 13 formed thereon. Accordingly, the panel guidelines 13 are integrally protruded from the outer spherical surface of the integrated ball bladder 10 for guiding the integrated ball cover 20 attaching on the integrated ball bladder 10, as shown in FIG. 8.

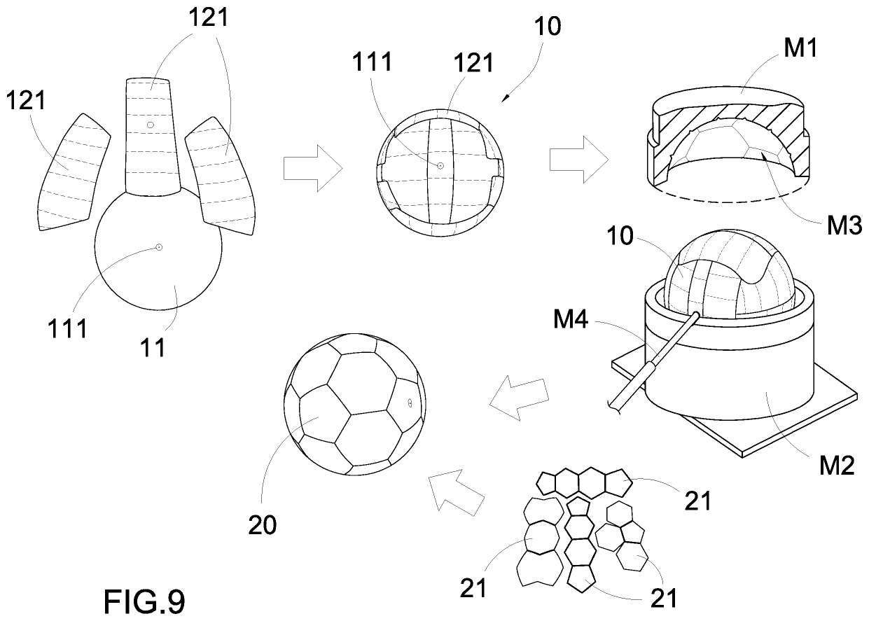

As shown in FIG. 9, in the step (1), the integrated ball bladder 10 is formed by the following steps.

(1.1) Encase the inflatable bladder 11 in the reinforcing carcass 12.

(1.2) Via the vulcanization process, integrally bond the inflatable bladder 11 with the reinforcing carcass 12 for forming the integrated ball bladder 10 in order to enhance a strength and roundness of the integrated ball bladder 10.

The step (1.2) further comprises a step of forming the panel guidelines 13 on the integrated ball bladder 10 via the vulcanization process. In the step (1.2), the inflatable bladder 11 with the reinforcing carcass 12 is disposed in a mold. The mold comprises an upper molding member M1 and a lower molding member M2, wherein each of the upper and lower molding members M1, M2 has a semi-spherical surface. When the upper and lower molding members M1, M2 are coupled with each other to receive the inflatable bladder 11 with the reinforcing carcass 12 therein, the reinforcing carcass 12 is contacted with the semi-spherical surfaces of the upper and lower molding members M1, M2, such that heat is applied to the semi-spherical surfaces of the upper and lower molding members M1, M2 to integrally bond the inflatable bladder 11 with the reinforcing carcass 12 for forming the integrated ball bladder 10.

Each of the upper and lower molding members M1, M2 further has a plurality of guideline grooves M3 indented on the semi-spherical surfaces, wherein during the vulcanization process, the fabric layers 121 of the reinforcing carcass 12 not only integrally bond with the outer spherical surface of the inflatable bladder 11 but also integrally protrudes from the outer spherical surface of the inflatable bladder 11 to form the panel guidelines 13 along the guideline grooves M3.

It is worth mentioning that an inflation tube M4 is inserted into the valve stem 111 of the integrated ball bladder 10 in order to inflate or deflate thereof. The inflation tube M4 not only serves as an initial reference guide for laminating the fabric layer 121 on the inflatable bladder 11 but also forms a handle to put the integrated ball bladder 10 in or out of the mold for guiding the panel guidelines 13 being formed on the integrated ball bladder 10 by the guideline grooves M3. In other words, after the inflatable bladder 11 is inflated by the inflation tube M4, the inflatable bladder 11 with the reinforcing carcass 12 can be carried by the inflation tube M4 in order to place the inflatable bladder 11 with the reinforcing carcass 12 into the mold. After the vulcanization process, the inflatable bladder 11 is integrated with the reinforcing carcass 12 to form the integrated ball bladder 10, such that the integrated ball bladder 10 is removed from the mold via the inflation tube M4.

According to the preferred embodiment, the integrated ball cover 20 comprises a plurality of ball panels 21 coupled on the integrated ball bladder 10 for encasing the integrated ball bladder 10 within the integrated ball cover 20 so as to form a sportsball and to form a plurality of ball channels 22 on the sportsball. Preferably, the ball panels 21 are initially adhered onto the outer spherical surface of the integrated ball bladder 10. Accordingly, each of the ball panels 21 is cut into a predetermined size and shape, wherein the panel guidelines 13 are integrally protruded from the outer spherical surface of the integrated ball bladder 10 for guiding the cover panels 21 attaching on the integrated ball bladder 10. In other words, edges of the cover panels 21 are aligned along the panel guidelines 13 respectively when the cover panels 21 are attached on the integrated ball bladder 10.

As shown in FIG. 2, each of the ball panels 21 comprises a cover panel 211 and a cushioning layer 212 overlappingly and integrally bonded with the cover panel 211, such that the cushioning layer 212 is adhered on the outer spherical surface of the integrated ball bladder 10 to encase the integrated ball bladder 10 by the cover panel 211.

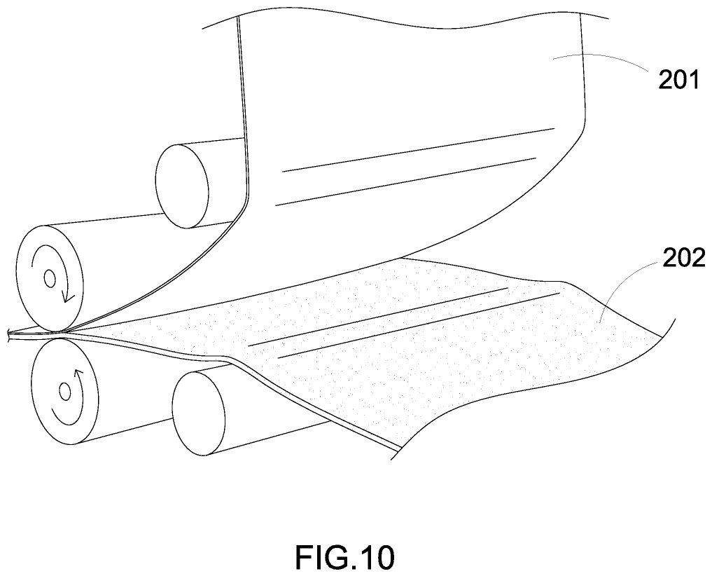

As shown in FIG. 10, in the step (2), the integrated ball cover 20 is formed by the following steps.

(2.1) Overlap an outer cover sheet 201 with an inner cover sheet 202.

(2.2) Via a roller pressing process, adhere the outer cover sheet 201 onto the inner cover sheet 202 in order to integrally bond the outer cover sheet 201 with the inner cover sheet 202 for pre-making the integrated ball cover 20 so as to form a ball cover sheet.

(2.3) Cut the integrated ball cover 20 into a plurality of ball panels 21.

Accordingly, the outer cover sheet 201 and the inner cover sheet 202 are fed to a roller pressing machine in order to overlap and adhere the outer cover sheet 201 and the inner cover sheet 202 together in the step (2.1), wherein adhesive is applied on at least one of the outer cover sheet 201 and the inner cover sheet 202.

During the roller pressing process in the step (2.2), pressure is applied via two rollers to press the outer cover sheet 201 and the inner cover sheet 202 with each other. In one example, the outer cover sheet 201 is made of TPU (Thermal Polyurethane) material. It is worth mentioning that the outer cover sheet 201 can also be made of durable material such as leather, Thermoplastic Urethane, Polyurethane (PU), Polyvinyl Chloride (PVC), Thermoplastic Elastomer (TPE), Ethylene-Vinyl Acetate (EVA), rubber, or other durable fabrics. The inner cover sheet 202 is made of foam material. The inner cover sheet 202 is adapted for providing a cushion effect for the sportsball to provide a softness for the sportsball and tolerate heavier impact thereon.

Therefore, the outer cover sheet 201 onto the inner cover sheet 202 are laminated together by adhesive to become a 2-layer panel. After the ball cover sheet as the integrated ball cover 20 is cut to form the ball panels 21, the outer cover sheet 201 and the inner cover sheet 202 are cut to form the cover panel 211 and the cushioning layer 212 of each of the ball panels 21. In other words, the outer cover sheet 201 and the inner cover sheet 202 are the cover panels 211 and the cushioning layers 212 respectively before the ball cover sheet is cut. Therefore, the cover panels 211 and the cushioning layers 212 are preferably made of TPU (Thermal Polyurethane) and foam material.

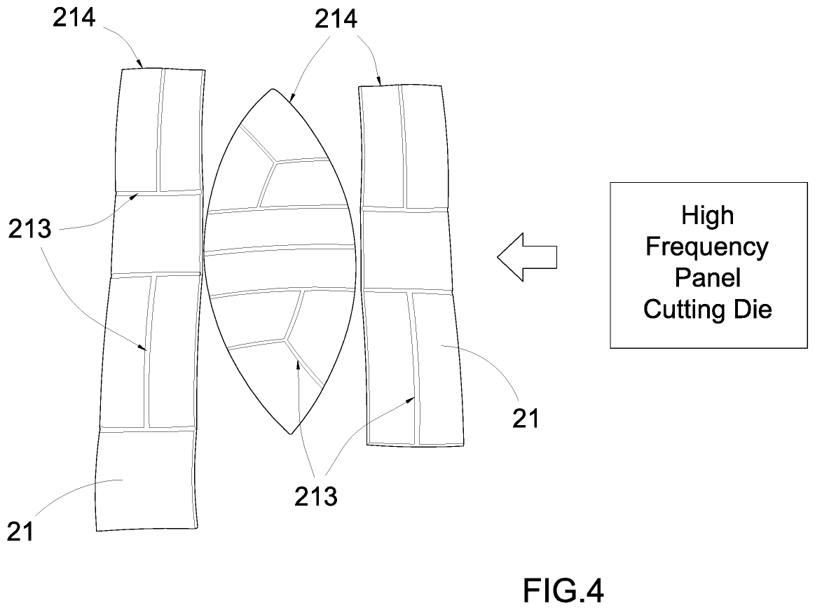

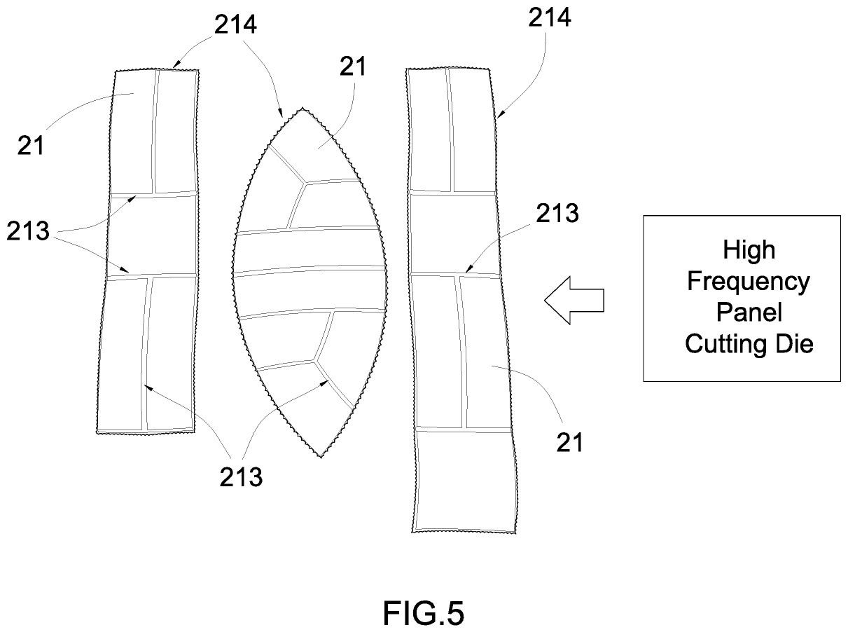

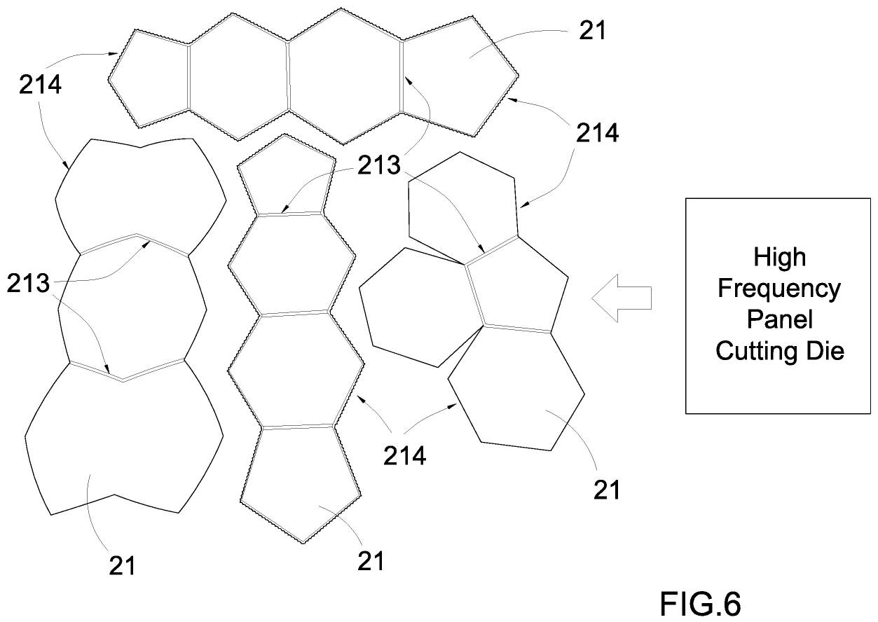

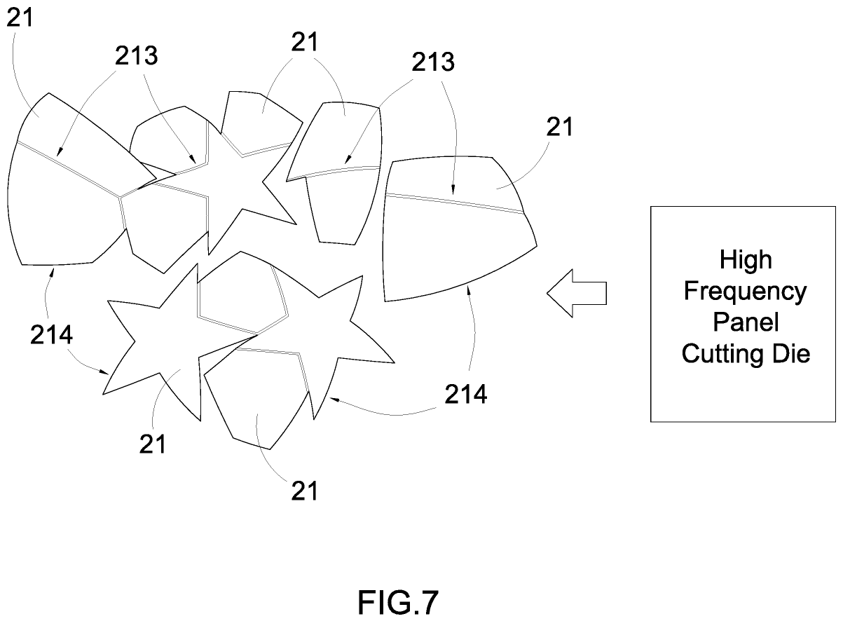

FIGS. 4 to 7 illustrate different contours of the cover panels 21. In one example, the ball panels 21 are cut into particular shapes to form a volleyball ball as the sportsball as shown in FIGS. 4 and 5. Each of the ball panels 21 has smooth edges as shown in FIG. 4. Each of the ball panels 21 has zigzagged edges as shown in FIG. 5. In another example, the ball panels 21 are cut into particular shapes to form a volleyball ball as the sportsball, as shown in FIGS. 6 and 7. The ball panels 21 are cut in conventional soccer ball panel shapes as shown in FIG. 6. The ball panels 21 are cut in new fashioned soccer ball panel shapes as shown in FIG. 7.

As shown in FIG. 8, each of said ball panels 21 further comprises one or more stitch-imitation edges 213 formed thereon and a plurality of channel edges 214 along edges of the ball panel 21, wherein the ball channels 22 are formed by the stitch-imitation edges 213 and the channel edges 214 after the ball panels 21 are attached on the integrated ball bladder 10.

Each of the stitch-imitation edges 213, having a predetermined length, is formed in an elongated configuration. Each of the stitch-imitation edges 213 has an outer edge indention portion 2131 indented on an outer surface of the ball panel 21 and an inner edge indention portion 2132 indented on an inner surface of the ball panel 21 to align with the outer edge indention portion 2131. In other words, each of the stitch-imitation edges 213 has a reduced thickness with respect to an overall thickness of the ball panel 21, wherein the thickness of the stitch-imitation edge 213 is reduced toward a mid-portion of the ball panel 21. Particularly, the outer edge indention portion 2131 is indented on the cover panel 211 while the inner edge indention portion 2132 is indented on the cushioning layer 212.

As shown in FIG. 8, the outer edge indention portion 2131 and the inner edge indention portion 2132 of the stitch-imitation edge 213 are identical to have a V-shaped configuration. When the ball panel 21 is attached on the integrated ball bladder 10, the inner edge indention portion 2132 of the stitch-imitation edge 213 is pressed on the outer spherical surface of the integrated ball bladder 10 while the outer edge indention portion 2131 of the stitch-imitation edge 213 is pressed to form the channel edge 22.

Each of the channel edges 214 has an outer tapered edge portion 2141 integrally extended from the outer surface of the ball panel 21 and an inner tapered edge portion 2142 integrally extended from the inner surface of the ball panel 21, such that the edge of each of the ball panels 21 form a tapered edge structure. In other words, each of the channel edges 214 has a reduced thickness with respect to an overall thickness of the ball panel 21, wherein the thickness of the channel edges 214 is reduced toward a mid-portion of the ball panel 21. Particularly, the outer tapered edge portion 2141 is tapered from the cover panel 211 while the inner tapered edge portion 2142 is tapered from the cushioning layer 212.

When the ball panels 21 are coupled edge-to-edge, as shown in FIG. 8, the inner tapered edge portions 2142 of the ball panels 21 are pressed on the outer spherical surface of the integrated ball bladder 10 while the inner tapered edge portions 2141 of the ball panels 21 pressed to form the channel edge 22. It is worth mentioning that the channel edges 22 formed by the stitch-imitation edge 213 are identical to the channel edges 22 formed by the channel edges 214.

Accordingly, in the step (2.3), the integrated ball cover 20 is cut by high frequency panel cutting die to form the ball panels, as shown in FIGS. 4 to 7. It is worth mentioning that one of the ball panels 21 has a through hole formed thereon to align with the valve stem 111 when the ball panel 21 is adhered on the integrated ball bladder 10. The step (2.3) further comprises the following steps.

(2.3.1) Form one or more stitch-imitation edges 213 on at least one of the ball panels 21.

(2.3.2) Form a plurality of channel edges 214 along edges of each of the ball panels 21.

It is worth mentioning that the stitch-imitation edges 213 and the channel edges 214 are formed on the ball panels 21 at the same time when the ball panels 21 are cut by the high frequency panel cutting die.

The step (3) further comprises the following step.

(3.1) Adhere the ball panels 21 onto the outer spherical surface of the integrated ball bladder 10 after adhesive is applied thereon, wherein the channel edges 214 of the ball panels 21 are aligned with the panel guidelines 13 on the integrated ball bladder 10 respectively. In other words, each of the ball panels 21 is adhered on the integrated ball bladder 10 at a desired location.

According to the first preferred embodiment of the present invention, the step (3) may further comprises the following step:

(3.2) Integrally bond the integrated ball cover 20 with the integrated ball bladder 10.

The step (3.2) is accomplished by the following steps. First, the integrated ball cover 20 and the integrated ball bladder 10 are placed into a ball mold which has an upper ball mold member and a lower ball mold member, wherein each of the upper and lower ball mold members has a semi-spherical surface. Second, when the upper and lower ball mold members are coupled with each other to receive the integrated ball cover 20 and the integrated ball bladder 10 therein, the ball panels 21 of the integrated ball cover 20 are contacted with the semi-spherical surfaces of the upper and lower ball mold members, such that a formation pressure, for example 6 kgs, and a heat, preferred around 38-45° C., are applied to the semi-spherical surfaces of the upper and lower ball mold members for a predetermined period of time, for example 2 minutes, to integrally bond the integrated ball cover 20 and the integrated ball bladder 10 for forming the sportsball.

It is worth mentioning that the inflation tube M4 is inserted into the valve stem 111 of the integrated ball bladder 10 in order to inflate or deflate thereof. The inflation tube M4 not only serves as an initial reference guide for laminating the ball panels 21 on the integrated ball bladder 10 but also forms a handle to put the integrated ball cover 20 with the integrated ball bladder 10 in or out of the ball mold. In other words, after the integrated ball bladder 10 is inflated by the inflation tube M4, the integrated ball cover 20 with the integrated ball bladder 10 can be carried by the inflation tube M4 in order to place the integrated ball cover 20 with the integrated ball bladder 10 into the ball mold. Thereafter, the integrated ball cover 20 is integrated with the integrated ball bladder 10 to form the sportsball, such that the sportsball is removed from the ball mold via the inflation tube M4.

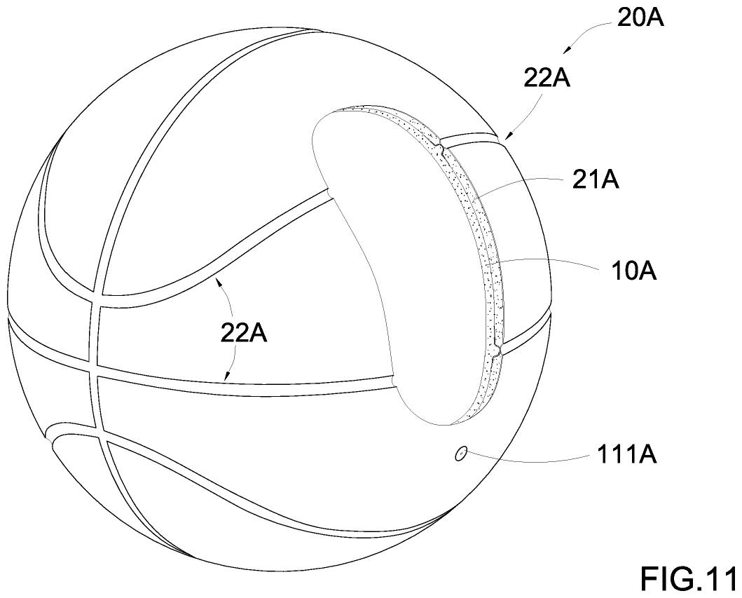

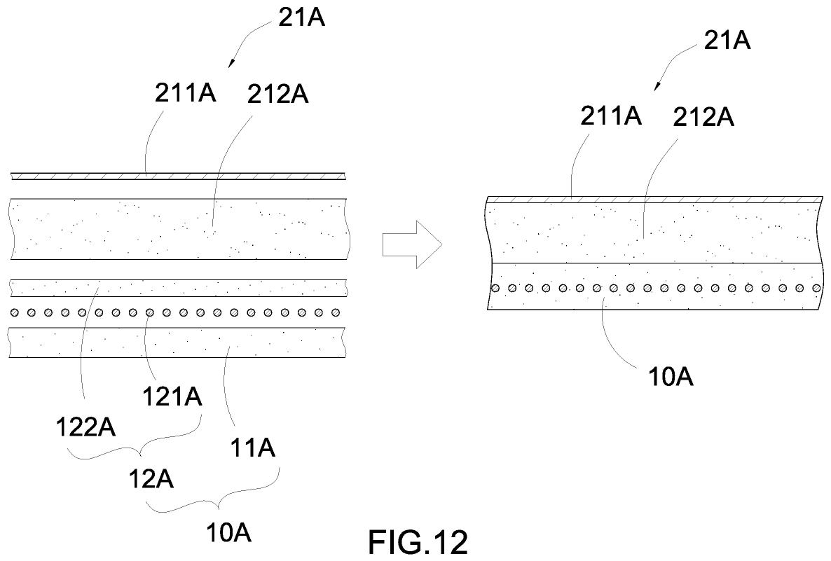

As shown in FIGS. 11 and 12, a stitchless sportsball according to a second embodiment illustrates an alternative mode of the first embodiment, wherein in this embodiment, the stitchless sportsball is shown as a basketball ball. According to the second embodiment, the stitchless sportsball comprises an integrated ball bladder 10A and an integrated ball cover 20A to encase the integrate ball bladder 10A therewithin. The method of manufacturing the stitchless sportsball comprises the following steps.

(1) Form the integrated ball bladder 10A

(2) Form the integrated ball cover 20A.

(3) Encase the integrated ball bladder 10A within the integrated ball cover 20A to form a sportsball.

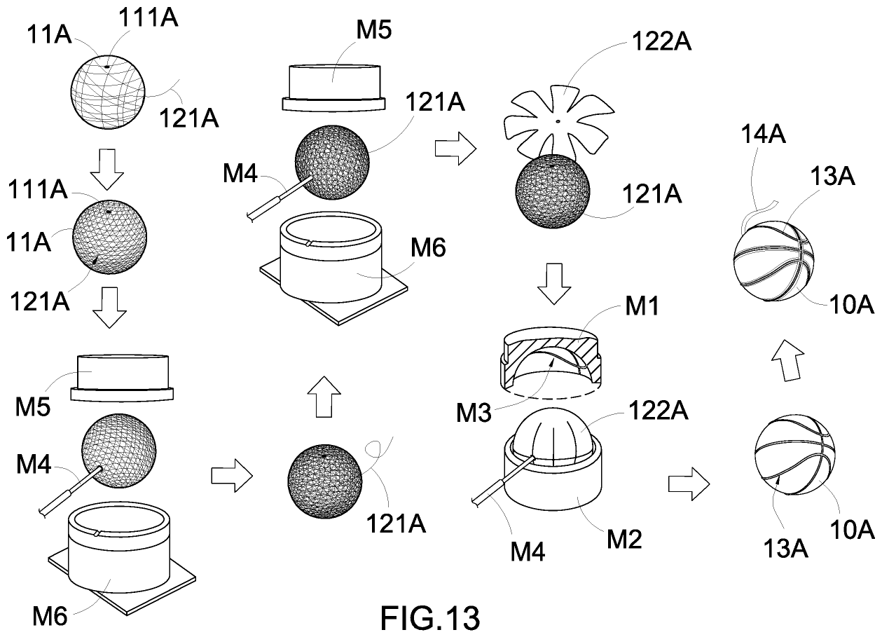

As shown in FIGS. 12 and 13, the integrated ball bladder 10A comprises an inflatable bladder 11A and a reinforcing carcass 12A, wherein the inflatable bladder 11A is encased in, vulcanized, and integrally bonded with the reinforcing carcass 12A for forming the integrated ball bladder 10A in order to enhance a strength and roundness of the integrated ball bladder 10A.

The integrated ball cover 20A comprises a plurality of ball panels 21A attached onto an outer spherical surface of the integrated ball bladder 10A, preferably by adhering agent, for encasing the integrated ball bladder 10A within the integrated ball cover 20A to form a sportsball and to form a plurality of ball channels 22A on the sportsball.

The inflatable bladder 11A according to the second embodiment is the same as that in the first embodiment, wherein the inflatable bladder 11A is an inflatable bladder having a valve stem 111A, such that the inflatable bladder 11A can be inflated via the valve stem 111A to have a spherical shape.

The reinforcing carcass 12A comprises a reinforcing thread 121A being wound around the outer spherical surface of the inflatable bladder 11A until the inflatable bladder 11A is enclosed by the reinforcing thread 121A, and a rubber layer 122A on the reinforcing thread 121A to sandwich the reinforcing thread 121A between the inflatable bladder 11A and the rubber layer 122A. Therefore, the reinforcing thread 121A not only integrally forms with each other to form the reinforcing carcass 12A in spherical shape but also integrally bond with the inflatable bladder 11A and the rubber layer 122A. It is worth mentioning that the reinforcing thread 121A embraces the inflatable bladder 11A for resisting stress and impact force applied to the inflatable bladder 11A.

In order to enable the reinforcing thread 121A being permanently affixed on the outer surface of the inflatable bladder 11A, before winding onto the inflatable bladder 11A, the outer surface of the inflatable bladder 11A is coated with adhesive to retain the reinforcing thread 121a thereon. Then, the inflatable bladder 11A with the adhered reinforcing threads 121A thereon are together cured by heat, such as the vulcanization process, in a mold, so that the reinforcing threads 121A will be hardened to form an exterior web layer which is permanently united with the inflatable bladder 11A integrally.

Preferably, more than one reinforcing thread 121A, as supplemental reinforcing threads, are wound around the outer spherical surface of the inflatable bladder 11A to enhance the strength of the reinforcing carcass 12A and to ensure the inflatable bladder 11A in a true roundness shape. In other words, after the exterior web layer is formed around the inflatable bladder 11A by the first reinforcing thread 121A, the adhesive is coated on the exterior web layer, such that a second reinforcing thread 121A is then adhered and wound around the exterior web layer. Then, the inflatable bladder 11A with the first and second reinforcing threads 121A thereon are together cured by the vulcanization process in a mold, so that the second reinforcing threads 121A will be hardened to form a second exterior web layer. Preferably, three reinforcing threads 121A is used for winding around the inflatable bladder 11A in sequence. Therefore, three vulcanization processes are completed in sequence to form three exterior web layers around the inflatable bladder 11A.

After one or more exterior web layers are formed to encase the inflatable bladder 11A by one or more of the reinforcing threads 121A, the rubber layer 122A is then overlapped on the exterior web layers, such that the inflatable bladder 11A with the reinforcing threads 121A are enclosed by the rubber layer 122A. Then, after the vulcanization process, the inflatable bladder 11A, the reinforcing threads 121A, and the rubber layer 122A are integrally bonded together.

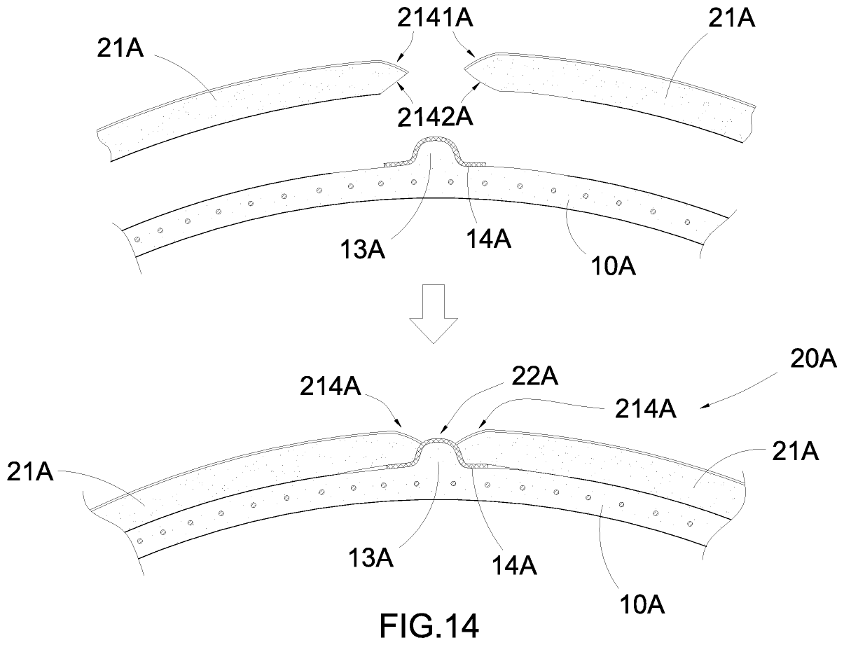

As shown in FIG. 14, the integrated ball bladder 10A further comprises a plurality of panel guidelines 13A formed thereon. Accordingly, the panel guidelines 13A are integrally protruded from the outer spherical surface of the integrated ball bladder 10A for guiding the integrated ball cover 20A attaching on the integrated ball bladder 10A. Particularly, the panel guidelines 13A are integrally formed with the rubber layer 122A, wherein the panel guidelines 13A are integrally protruded from the rubber layer 122A.

According to the second embodiment, the integrated ball bladder 10A further comprises a plurality of channel strips 14A attached on the integrated ball bladder 10A along the panel guidelines 13A respectively to form the ball channels 22A after the cover panels 21A are attached on the integrated ball bladder 10A.

As shown in FIG. 13, in the step (1), the integrated ball bladder 10A is formed by the following steps.

(1.1) Encase the inflatable bladder 11A in the reinforcing carcass 12A.

(1.2) By applying heat, such as via the vulcanization process, integrally bond the inflatable bladder 11A with the reinforcing carcass 12A for forming the integrated ball bladder 10A in order to enhance a strength and roundness of the integrated ball bladder 10A.

According to the second embodiment, the step (1.1) further comprises the following steps.

(1.1.1) Apply the adhesive on the outer spherical surface of the inflatable bladder 11A after the inflatable bladder 11A is inflated. Accordingly, the inflation tube M4 is inserted into the valve stem 111A of the inflatable bladder 11A in order to inflate thereof. The inflatable tube M4 also serves as a handle of the inflatable bladder 11A, such that the adhesive can be easily and evenly applied on the outer spherical surface of the inflatable bladder 11A.

(1.1.2) Wind the reinforcing thread 121A around the outer spherical surface of the inflatable bladder 11A until the inflatable bladder 11A is enclosed by the reinforcing thread 121A.

(1.1.3) Shape and harden the reinforcing thread 121A to form the exterior web layer for encasing the inflatable bladder 11A in a shaping mold which comprises an upper shaping mold member M5 and a lower shaping mold member M6. If necessary, repeat the steps (1.1.2) and (1.1.3) to wind second and third reinforcing threads 121A around the inflatable bladder 11A and to form a plurality of exterior web layers around the inflatable bladder 11A in sequence.

(1.1.4) Apply the rubber layer 122A on the reinforcing thread 121A to sandwich the reinforcing thread 121A between the inflatable bladder 11A and the rubber layer 122A. After heat is applied, such as the vulcanization process, the reinforcing thread 121A not only integrally forms with each other to form the reinforcing carcass 12A in spherical shape but also integrally bond with the inflatable bladder 11A and the rubber layer 122A. Accordingly, the inflatable bladder 11A wound with the reinforcing thread 121A, and the rubber layer 122A are disposed in the mold. As it is mentioned above, the mold is constructed to have the upper molding member M1 and the lower molding member M2, wherein each of the upper and lower molding members M1, M2 has a semi-spherical surface. When the upper and lower molding members M1, M2 are coupled with each other to receive the inflatable bladder 11A, the reinforcing thread 121A, and the rubber layer 122A therein, the rubber layer 122A is contacted with the semi-spherical surfaces of the upper and lower molding members M1, M2, such that heat is applied to the semi-spherical surfaces of the upper and lower molding members M1, M2 to integrally bond the inflatable bladder 11A, the reinforcing thread 121A, and the rubber layer 122A together for forming the integrated ball bladder 10A.

(1.1.5) Form the panel guidelines 13A on the integrated ball bladder 10A. Accordingly, each of the upper and lower molding members M1, M2 further has a plurality of guideline grooves M3 indented on the semi-spherical surfaces, wherein during the vulcanization process, the rubber layer 122A of the reinforcing carcass 12A not only integrally bond with the inflatable bladder 11A and the reinforcing thread 121A but also integrally protrudes from the outer spherical surface of the rubber layer 122A to form the panel guidelines 13A along the guideline grooves M3.

(1.1.6) Attach the channel strips 14A on the integrated ball bladder 10A along the panel guidelines 13A respectively to form the ball channels 22A after the cover panels 21A are attached on the integrated ball bladder 10A. Preferably, the channels strips 14A are adhered on the integrate ball bladder 10A along the panel guidelines 13A respectively. A width of the channel strip 14A is wider than a width of the panel guideline 13A, such that the panel guideline 13A is covered by the channel strip 14A after the channel strip 14A is adhered along the panel guideline 13A.

(1.1.7) Buffer and clean the integrated ball bladder 10A for smoothing the outer spherical surface of the integrated ball bladder 10A with the channel strips 14A thereon.

According to the second embodiment, the manufacturing process of the integrated ball cover 20A is the same as that of the first embodiment. The difference between the first and second embodiments is the shape of the ball panel 21A for making the basketball ball in the second embodiment. Therefore, each of the ball panels 21A is constructed to have the cover panel 211A and the cushioning layer 212A overlappingly and integrally bonded with the cover panel 211A.

Furthermore, the ball panel 21A does not have any stitch-imitation edges 213 because the stitchless sportsball is made to form the basketball ball in the second embodiment. Accordingly, each of said ball panels 21A further comprises a plurality of channel edges 214A along edges of the ball panel 21A, wherein the ball channels 22 are formed by the channel edges 214A after the ball panels 21A are attached on the integrated ball bladder 10A.

As shown in FIG. 14, each of the channel edges 214A has an outer tapered edge portion 2141A integrally extended from the outer surface of the ball panel 21A and an inner tapered edge portion 2142A integrally extended from the inner surface of the ball panel 21A, such that the edge of each of the ball panels 21A form a tapered edge structure. In other words, each of the channel edges 214A has a reduced thickness with respect to an overall thickness of the ball panel 21A, wherein the thickness of the channel edges 214A is reduced toward a mid-portion of the ball panel 21A. Particularly, the outer tapered edge portion 2141A is tapered from the cover panel 211A while the inner tapered edge portion 2142A is tapered from the cushioning layer 212A.

The channel edge 214A of the ball panel 21A is aligned along the panel guideline 13A when the ball panel 21A is coupled on the integrated ball bladder 10A. In other words, the panel guideline 13A is aligned and located along two channel edges 214A of the ball panels 21A as shown in FIG. 14. The inner tapered edge portions 2142A of the ball panels 21A are pressed on the outer spherical surface of the integrated ball bladder 10A while the outer tapered edge portions 2141A of the ball panels 21A pressed to form the channel edge 22A. As it is mentioned above, the panel guideline 13A is covered by the channel strip 14A after the channel strip 14A is adhered along the panel guideline 13A. In other words, two longitudinal edge portions of the channel strip 14A are adhered on the outer spherical surface of the integrated ball bladder 10A while the panel guideline 13A is covered by a longitudinal mid-portion of the channel strip 14A.

In order to form the ball channel 22, the inner tapered edge portions 2142A of the ball panels 21A are pressed and adhered on the outer spherical surface of the integrated ball bladder 10A to cover the longitudinal edge portions of the channel strip 14A respectively. Then, the longitudinal mid-portion of the channel strip 14A is exposed to form the ball channel 22 between two outer tapered edge portions 2141A of the ball panels 21A as shown in FIG. 14. It is worth mentioning that the material of the channel strip 14A is different from the cover panel 211A for creating different gripping abilities of the stitchless sportsball to provide a better control therefor.

According to the second embodiment, the step (3) further comprises the following step.

(3.1) Adhere the ball panels 21A onto the outer spherical surface of the integrated ball bladder 10 after adhesive is applied thereon, wherein the channel edges 214A of the ball panels 21A are aligned with the panel guidelines 13A on the integrated ball bladder 10A respectively. In other words, each of the ball panels 21 is adhered on the integrated ball bladder 10A at a desired location.

Similarly, the step (3) of the second preferred embodiment of the present may also comprises the following step:

(3.2) Integrally bond the integrated ball cover 20 with the integrated ball bladder 10.

The step (3.2) is accomplished by the following steps. First, the integrated ball cover 20 and the integrated ball bladder 10 are placed into a ball mold which has an upper ball mold member and a lower ball mold member, wherein each of the upper and lower ball mold members has a semi-spherical surface. Second, when the upper and lower ball mold members are coupled with each other to receive the integrated ball cover 20 and the integrated ball bladder 10 therein, the ball panels 21 of the integrated ball cover 20 are contacted with the semi-spherical surfaces of the upper and lower ball mold members, such that a formation pressure, for example 6 kgs, and a heat, preferred around 38-45° C., are applied to the semi-spherical surfaces of the upper and lower ball mold members for a predetermined period of time, for example 2 minutes, to integrally bond the integrated ball cover 20 and the integrated ball bladder 10 for forming the sportsball.

Likewise, the inflation tube M4 is inserted into the valve stem 111 of the integrated ball bladder 10 in order to inflate or deflate thereof. The inflation tube M4 not only serves as an initial reference guide for laminating the ball panels 21 on the integrated ball bladder 10 but also forms a handle to put the integrated ball cover 20 with the integrated ball bladder 10 in or out of the ball mold. In other words, after the integrated ball bladder 10 is inflated by the inflation tube M4, the integrated ball cover 20 with the integrated ball bladder 10 can be carried by the inflation tube M4 in order to place the integrated ball cover 20 with the integrated ball bladder 10 into the ball mold. Thereafter, the integrated ball cover 20 is integrated with the integrated ball bladder 10 to form the sportsball, such that the sportsball is removed from the ball mold via the inflation tube M4.

Accordingly, all the features in the above preferred embodiments are interchangeable to achieve the objective of the present invention. For example, the integrated ball cover 10 with the fabric layers 121 of the first embodiment can be configured to form the basketball ball by attaching the channel strips 14A on the integrated ball bladder 10 along the panel guidelines 13 respectively and by attaching the ball panels 21A of the second embodiment. Likewise, the integrated ball cover 10A with the reinforcing thread 121A and the rubber layer 122A of the second embodiment can be configured to form the volleyball ball or soccer ball by attaching the ball panels 21 of the first embodiment. In other words, the integrated ball bladder 10, 10A and the integrated ball cover 20, 20A of the first and second embodiments can be interchangeably used in different applications and can be modified to ensure the strength of the stitchless sportsball. Therefore, the present invention provides a simple but effective configuration for providing a simple and strengthened ball configuration for manufacturing a stitchless sportsball with integrated and strengthened ball bladder.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of manufacturing a stitchless sportsball, comprising the steps of:
(a) forming an integrated ball bladder, having an outer spherical surface, by the steps of:
(a.1) encasing an inflatable bladder in a reinforcing carcass; and
(a.2) via a vulcanization process, integrally bonding said inflatable bladder with said reinforcing carcass for forming said integrated ball bladder in order to enhance a strength and roundness of said integrated ball bladder;
(b) pre-making an integrated ball cover;
(c) cutting said integrated ball cover into a plurality of ball panels; and
(d) bonding said ball panels onto said outer spherical surface of said integrated ball bladder for encasing said integrated ball bladder within said integrated ball cover to form a sportsball with a plurality of ball channels formed thereon.

2. The method, as recited in claim 1, wherein the step (a.1) further comprises the steps of:
(a.1.1) applying adhesive on an outer spherical surface of said inflatable bladder after said inflatable bladder is inflated; and
(a.1.2) wrapping a plurality of fabric layers on said outer spherical surface of said inflatable bladder, wherein edge portions of said fabric layers are overlapped with each other on said outer spherical surface of said inflatable bladder, such that after said vulcanization process, said fabric layers not only integrally bond with each other to form said reinforcing carcass but also integrally bond on said outer spherical surface of said inflatable bladder.

3. The method, as recited in claim 2, wherein the step (a.2) further comprises a step of forming a plurality of panel guidelines on said integrated ball bladder via said vulcanization process, wherein said panel guidelines are integrally protruded from said outer spherical surface of said integrated ball bladder for guiding said cover panels attaching on said integrated ball bladder.

4. The method, as recited in claim 3, wherein said panel guidelines are integrally formed and protruded from said fabric layers after said fabric layers are integrally bond on said outer spherical surface of said inflatable bladder.

5. The method, as recited in claim 1, wherein the step (a.1) further comprises the steps of:
(a.1.1) applying adhesive on an outer spherical surface of said inflatable bladder after said inflatable bladder is inflated;
(a.1.2) winding a reinforcing thread around said outer spherical surface of said inflatable bladder until said inflatable bladder is enclosed by said reinforcing thread; and
(a.1.3) applying a rubber layer on said reinforcing thread to sandwich said reinforcing thread between said inflatable bladder and said rubber layer, wherein after said vulcanization process, said reinforcing thread not only integrally forms with each other to form said reinforcing carcass in spherical shape but also integrally bond with said inflatable bladder and said rubber layer.

6. The method, as recited in claim 5, wherein the step (a.2) further comprises a step of forming a plurality of panel guidelines on said integrated ball bladder via said vulcanization process, wherein said panel guidelines are integrally protruded from said outer spherical surface of said integrated ball bladder for guiding said cover panels attaching on said integrated ball bladder.

7. The method, as recited in claim 6, wherein said panel guidelines are integrally formed and protruded from said rubber layer after said rubber layer is integrally bond on said outer spherical surface of said inflatable bladder.

8. The method, as recited in claim 6, wherein the step (a.2) further comprises a step of adhering a plurality of channel strips on said integrated ball bladder along said panel guidelines respectively to form said ball channels after said cover panels are attached on said integrated ball bladder.

9. The method, as recited in claim 5, after the step (a.1.2) and before the step (a.1.3), further comprising the steps of:
(a.1.2.1) via said vulcanization process, integrally bonding said reinforcing thread around said outer spherical surface of said inflatable bladder; and
(a.1.2.2) winding a supplemental reinforcing thread around said outer spherical surface of said inflatable bladder until said inflatable bladder with said reinforcing thread is enclosed by said supplemental reinforcing thread; and
(a.1.2.3) via said vulcanization process, integrally bonding said supplemental reinforcing thread around said inflatable bladder with said reinforcing thread.

10. The method, as recited in claim 1, wherein the step (b) further comprises a the steps of:
(b.1) overlapping an outer cover sheet with an inner cover sheet;
(b.2) via a roller pressing process, adhering said outer cover sheet onto said inner cover sheet in order to integrally bond said outer cover sheet with said inner cover sheet for pre-making said integrated ball cover, wherein after said integrated ball cover is cut to form said ball panels, said outer cover sheet and said inner cover sheet are cut to form a cover panel and a cushioning layer of each of said ball panels.

11. The method, as recited in claim 1, wherein the step (c) further comprises a the steps of:
(c.1) forming one or more stitch-imitation edges on at least one of said ball panels, wherein each of said stitch-imitation edges has an outer edge indention portion indented on an outer surface of said ball panel and an inner edge indention portion indented on an inner surface of said ball panel to align with said outer edge indention portion; and
(c.2) forming a plurality of channel edges along edges of each of said ball panels, wherein each of said channel edges has an outer tapered edge portion integrally extended from said outer surface of said ball panel and an inner tapered edge portion integrally extended from said inner surface of said ball panel, such that said edges of said ball panels form a tapered edge structure.

12. The method, as recited in claim 11, wherein said ball channels are formed by said stitch-imitation edges and said channel edges.

13. The method, as recited in claim 12, wherein said outer edge indention portion and said inner edge indention portion of said stitch-imitation edge are identical to have a V-shaped configuration, such that when said ball panel is attached on said integrated ball bladder, said inner edge indention portion of said stitch-imitation edge is pressed on said outer spherical surface of said integrated ball bladder while said outer edge indention portion of said stitch-imitation edge is pressed to form said channel edge.

14. The method, as recited in claim 12, wherein, when said ball panels are coupled edge-to-edge, said inner tapered edge portions of said ball panels are pressed on said outer spherical surface of said integrated ball bladder while outer inner tapered edge portions of said ball panels pressed to form said channel edge.

15. The method as recited in claim 1 wherein, in the step (c), said integrated ball cover is cut by high frequency panel cutting die to form said ball panels.

16. A stitchless sportsball, comprising:
an integrated ball bladder which comprises an inflatable bladder and a reinforcing carcass, wherein said inflatable bladder is encased in, vulcanized, and integrally bonded with said reinforcing carcass for forming said integrated ball bladder in order to enhance a strength and roundness of said integrated ball bladder; and
an integrated ball cover which comprises a plurality of ball panels bonded onto an outer spherical surface of said integrated ball bladder for encasing said integrated ball bladder within said integrated ball cover to form a sportsball with a plurality of ball channels formed thereon.

17. The stitchless sportsball, as recited in claim 16, wherein said reinforcing carcass comprises a plurality of fabric layers vulcanized and integrally bonded on an outer spherical surface of said inflatable bladder.

18. The stitchless sportsball, as recited in claim 17, wherein said integrated ball bladder further comprises a plurality of panel guidelines formed integrally, wherein said panel guidelines are integrally formed with said fabric layer and are integrally protruded from said outer spherical surface of said integrated ball bladder for guiding said cover panels attaching on said integrated ball bladder.

19. The stitchless sportsball, as recited in claim 16, wherein said reinforcing carcass comprises a reinforcing thread being wound around said outer spherical surface of said inflatable bladder until said inflatable bladder is enclosed by said reinforcing thread, and a rubber layer on said reinforcing thread to sandwich said reinforcing thread between said inflatable bladder and said rubber layer, wherein said reinforcing thread not only integrally forms with each other to form said reinforcing carcass in spherical shape but also integrally bond with said inflatable bladder and said rubber layer.

20. The stitchless sportsball, as recited in claim 19, wherein said integrated ball bladder further comprises a plurality of panel guidelines formed integrally, wherein said panel guidelines are integrally formed with said rubber layer and are integrally protruded from said outer spherical surface of said integrated ball bladder for guiding said cover panels attaching on said integrated ball bladder.

21. The stitchless sportsball, as recited in claim 20, wherein said integrated ball bladder further comprises a plurality of channel strips attached on said integrated ball bladder along said panel guidelines respectively to form said ball channels after said cover panels are attached on said integrated ball bladder.

22. The stitchless sportsball, as recited in claim 16, wherein each of said ball panels comprises a cover panel and a cushioning layer overlappingly and integrally bonded with said cover panel, such that said cushioning layer is adhered on said outer spherical surface of said integrated ball bladder to encase said integrated ball bladder by said cover panel.

23. The stitchless sportsball, as recited in claim 22, wherein each of said ball panels further comprises one or more stitch-imitation edges formed thereon and a plurality of channel edges along edges of said ball panel, wherein said ball channels are formed by said stitch-imitation edges and said channel edges.

24. The stitchless sportsball, as recited in claim 23, wherein each of said stitch-imitation edges has an outer edge indention portion indented on an outer surface of said ball panel and an inner edge indention portion indented on an inner surface of said ball panel to align with said outer edge indention portion.

25. The stitchless sportsball, as recited in claim 24, wherein said outer edge indention portion and said inner edge indention portion of said stitch-imitation edge are identical to have a V-shaped configuration, such that when said ball panel is attached on said integrated ball bladder, said inner edge indention portion of said stitch-imitation edge is pressed on said outer spherical surface of said integrated ball bladder while said outer edge indention portion of said stitch-imitation edge is pressed to form said channel edge.

26. The stitchless sportsball, as recited in claim 23, wherein each of said channel edges has an outer tapered edge portion integrally extended from said outer surface of said ball panel and an inner tapered edge portion integrally extended from said inner surface of said ball panel, such that said edge of each of said ball panels form a tapered edge structure.

27. The stitchless sportsball, as recited in claim 26, wherein when said ball panels are coupled edge-to-edge, said inner tapered edge portions of said ball panels are pressed on said outer spherical surface of said integrated ball bladder while said outer tapered edge portions of said ball panels pressed to form said channel edge.
